(19) United States
(12) Patent Application Publication
(10) Pub. No.: US 2014/0143051 A1
(43) Pub. Date: May 22, 2014

(54) NABST Market Mechanism - Highly Targeted Advertising Method

(71) Applicant: Jason Michael Badyrka, Houston, TX (US)

(72) Inventor: Jason Michael Badyrka, Houston, TX (US)

(21) Appl. No.: 14/078,263

(22) Filed: Nov. 12, 2013

Related U.S. Application Data
(62) Division of application No. 12/286,379, filed on Sep. 29, 2008.

(51) Int. Cl. G06Q 30/02

(52) U.S. Cl. CPC G06Q 30/0255
USPC 705/14.53

(57) ABSTRACT

Enables self-serving consumer to indicate their personal element of unsatisfied demand for a particular product so they are alerted to modified supply (promotional information) for the product. Potential buyers communicate the store of product observation and a product of interest to a communications host. The store and product information, together with a return address for responsive communications concerning the store and the product, is stored in a database. A seller interested in demand at their establishment could access the database and retrieve aggregate buyer-segmented product demand information for the consumer they target. The seller could design incentive schemes more effectively and communicate promotional information to the potential buyer via the communications host. The communication is highly targeted, enhances economic communication of unsatisfied demand and delivers promotional advertising information to self-targeted consumers with protection from unsolicited seller spam.

### CROSS-REFERENCE TO RELATED APPLICATIONS

This is a division of application Ser. No. 12/286,379, Filed 2008 Sep. 29 and now pending, to the non-elected species of an election requirement. This is also a Continuation-in-Part of application Ser. No. 12/286,379, Filed 2008 Sep. 29 by the present inventor. This application claims the benefit of U.S. Provisional Patent Application Ser. No. 61/127,402 filed 2008 May 13 and Disclosure Document 606960 filed 2006 Oct. 2.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

In preferred aspects, this invention relates to methods for electronically communicating economic information regarding unsatisfied demand and modified supply of goods. More specifically, highly targeted promotional information responsive to a request for that information.

### BACKGROUND OF THE INVENTION

Resource: The New Institutional Economics—Texas A&M University Press “The emphasis now is on enlarging the scope of standard micro theory by taking account of previously neglected features of the economic system. In order for an exchange between two parties, it is necessary that the two search each other out, which is costly in terms of time and resources. If the search is successful and the parties make contact they must inform each other of the exchange opportunity that may be present, and the conveying of such information will again require resources. If there is a potential bargain to be struck, some costs of decision making will be incurred before terms of a trade can be decided on. Then there is implementation and notification to the consumer.

The core problem of the economic organization of society is that of facing and dealing with uncertainty. Primary uncertainty is of a state contingent kind arising from random acts of nature and unpredictable changes in consumer preferences. The secondary uncertainty arises from ‘lack of communication’. Obviously prices do not vary at every moment which there is a change in the demand or supply, but what is the right interval for renegotiation or change in price? The supplier is prepared, indeed desires, to make future revisions that both parties would have agreed to if the true state of demand and supply was readily known. If appropriate decisions are to be taken, suppliers must not only have access to certain types of strategic information but have confidence the information received is reliable. The absence of reliable information in the system tends to prevent the attainment of a superior allocative solution. Given this understanding, the next step is to explore some new arrangements designed to overcome the information problem and reduce allocative inefficiencies.

The group incentive mechanism typically assumes that suppliers are unable to foresee the characteristics or the thought process of the consumer whom they target. This inability leads to complications in the design of incentive schemes. However in reality, it is often not the case that consumer demands are really unobservable; rather, they may be very costly to observe. One may choose to model high-costs actions as being infeasible actions, but in doing so, one may miss some interesting phenomena. Simply because information gathering is traditionally costly for suppliers does not mean it is costly to everyone. With the right incentive the self-serving consumer is in the perfect position to help monitor themselves. Information suppliers want can be enticed from self-serving man with a reward for participation.”—Paraphrased For Emphasis—

### DESCRIPTION OF PRIOR ART

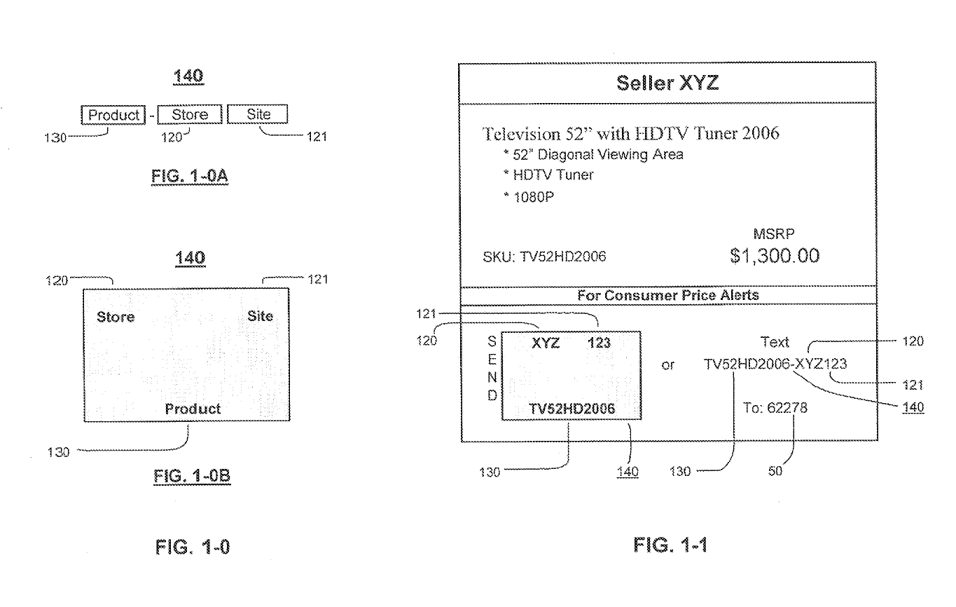

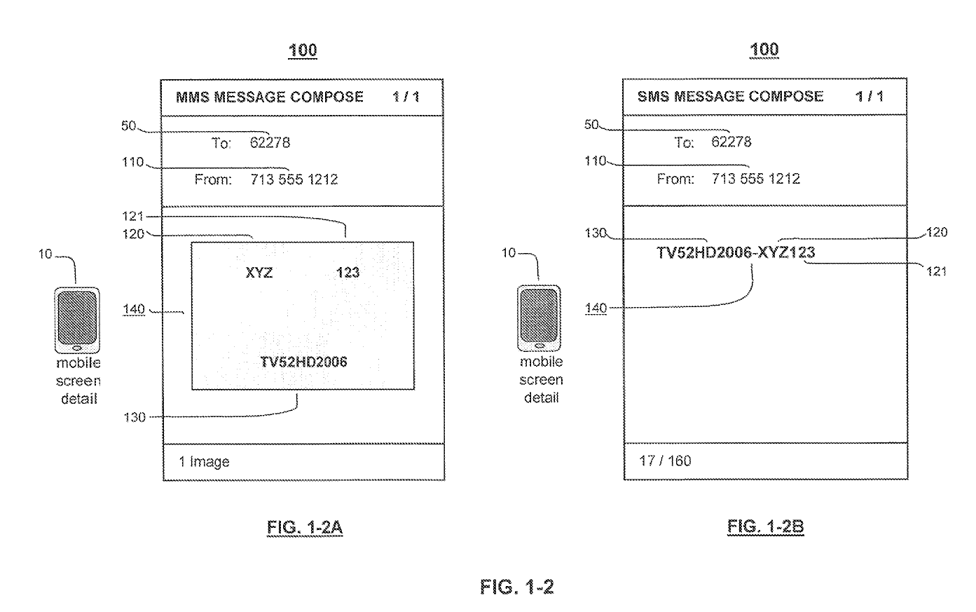

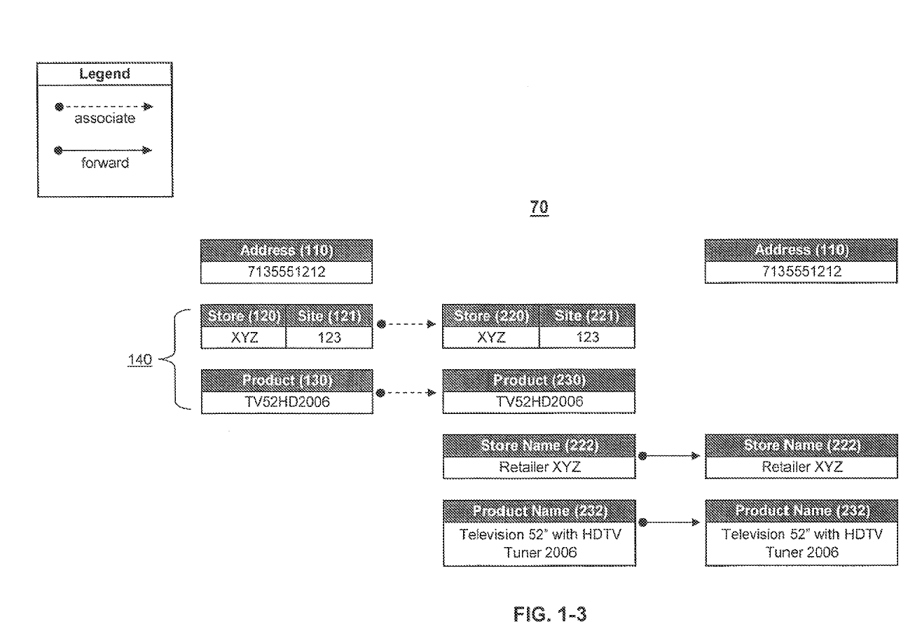

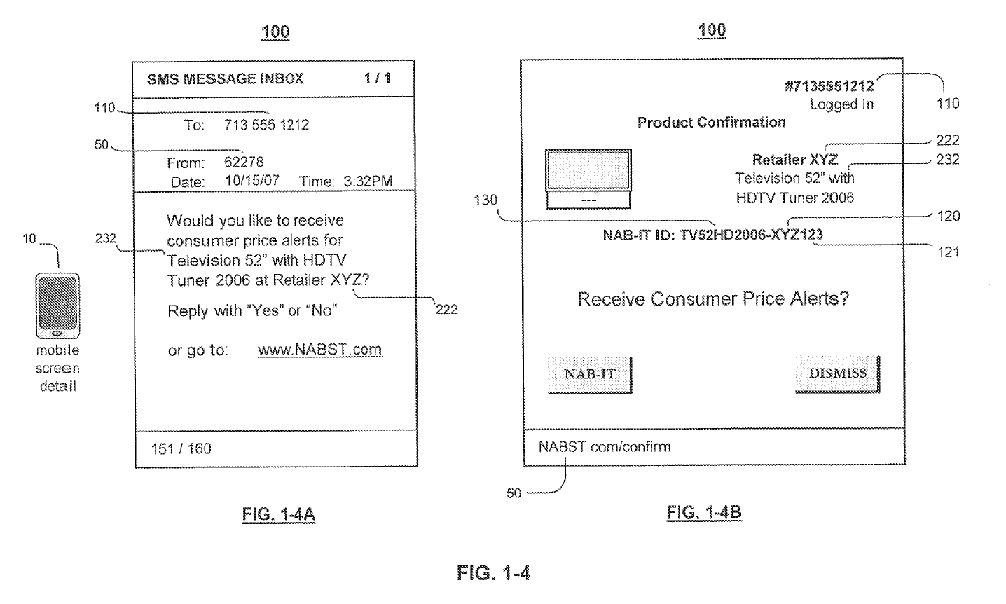

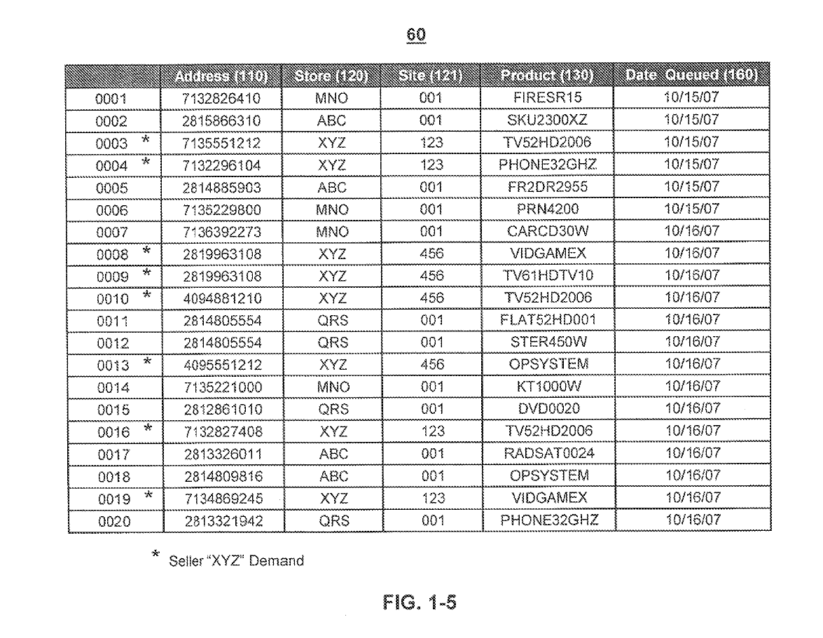

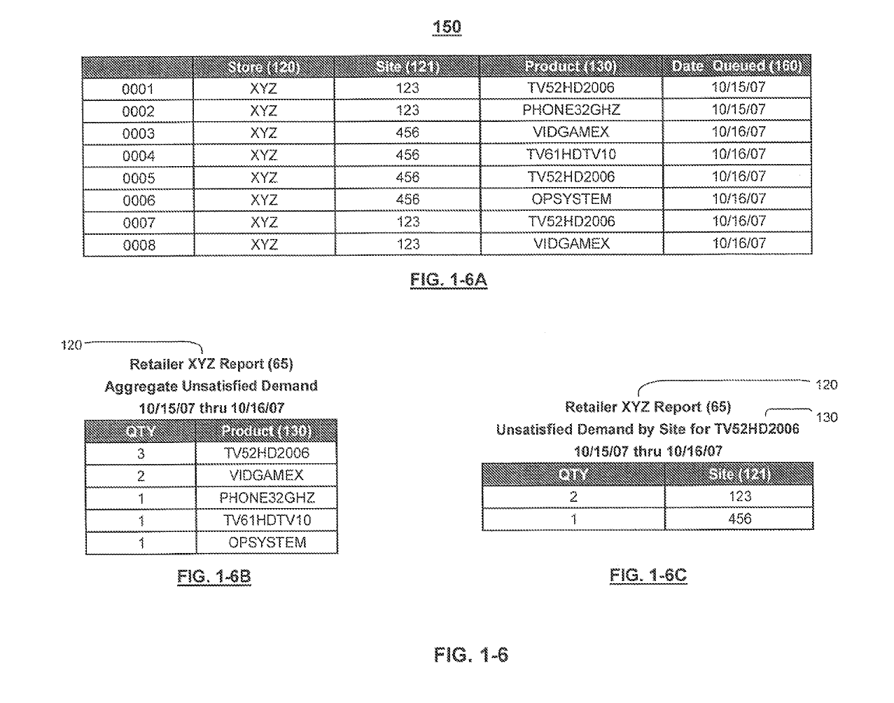

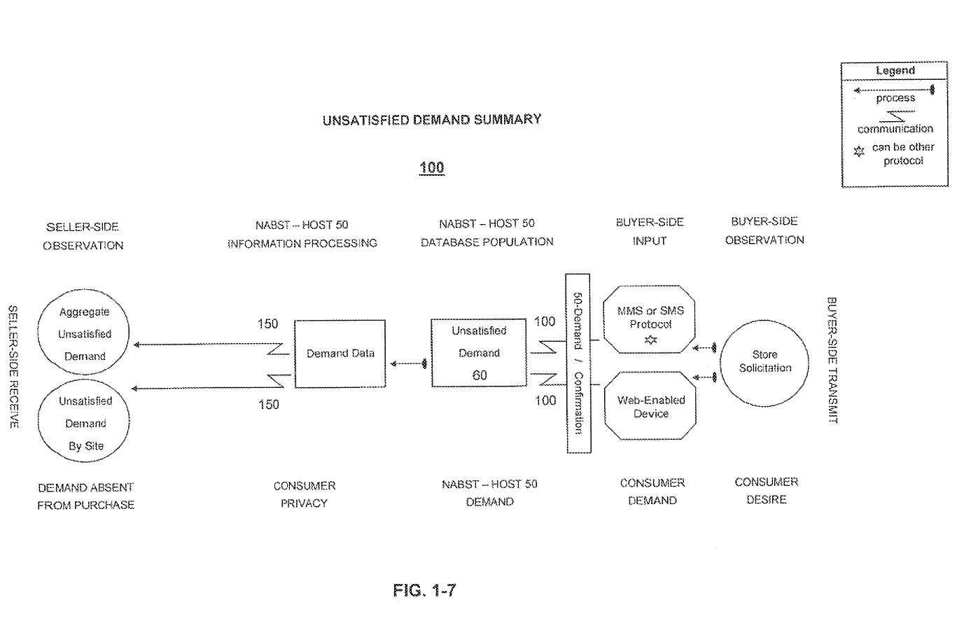

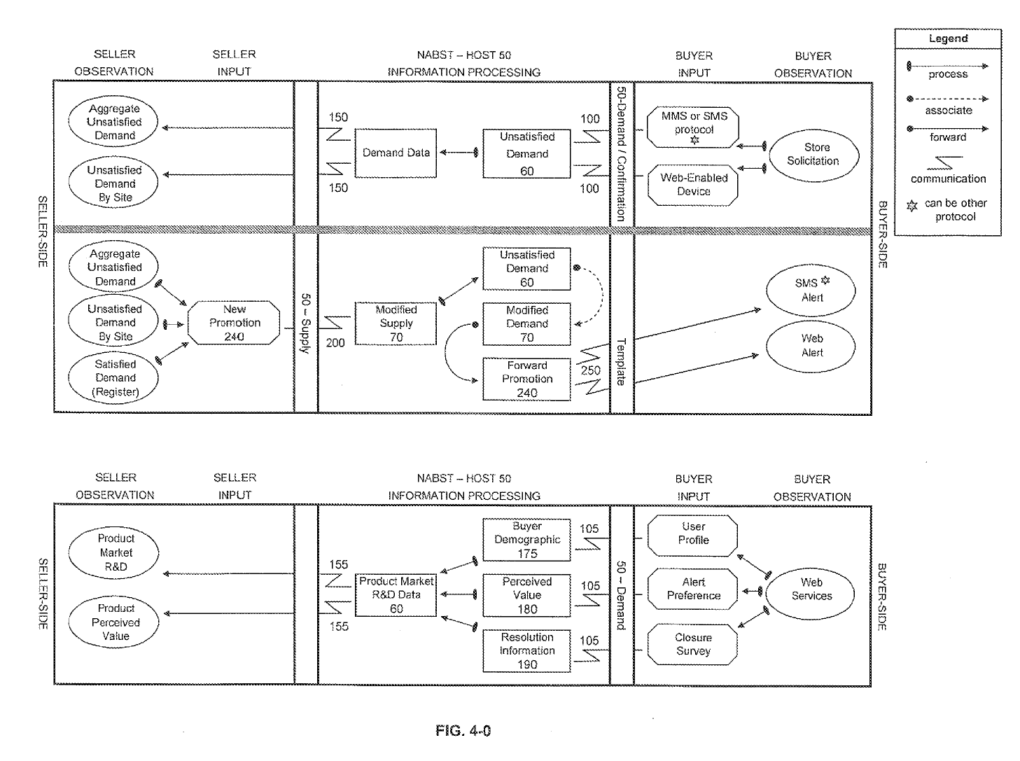

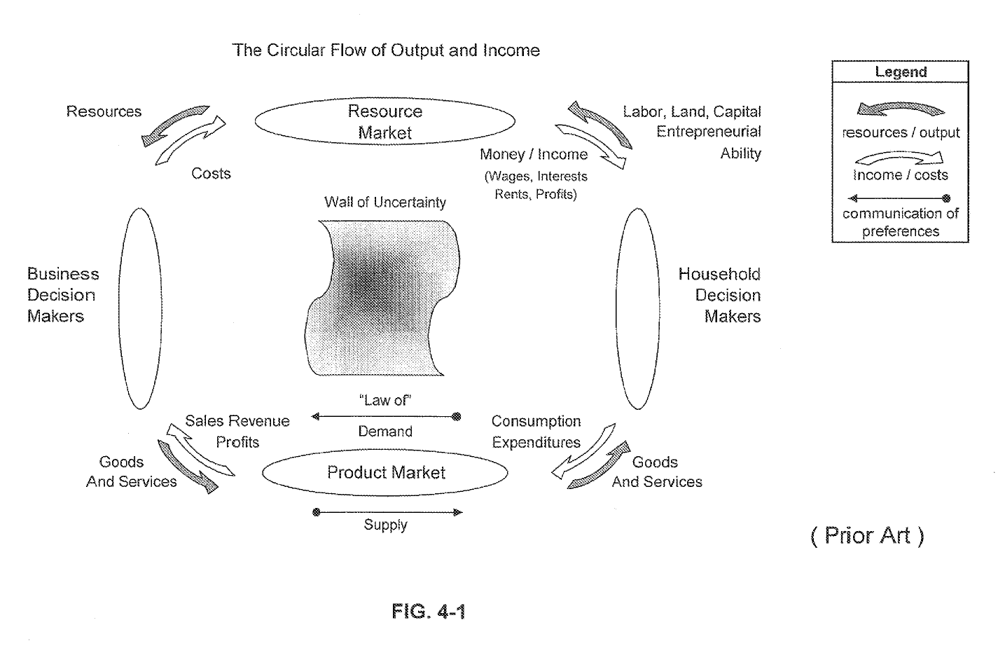

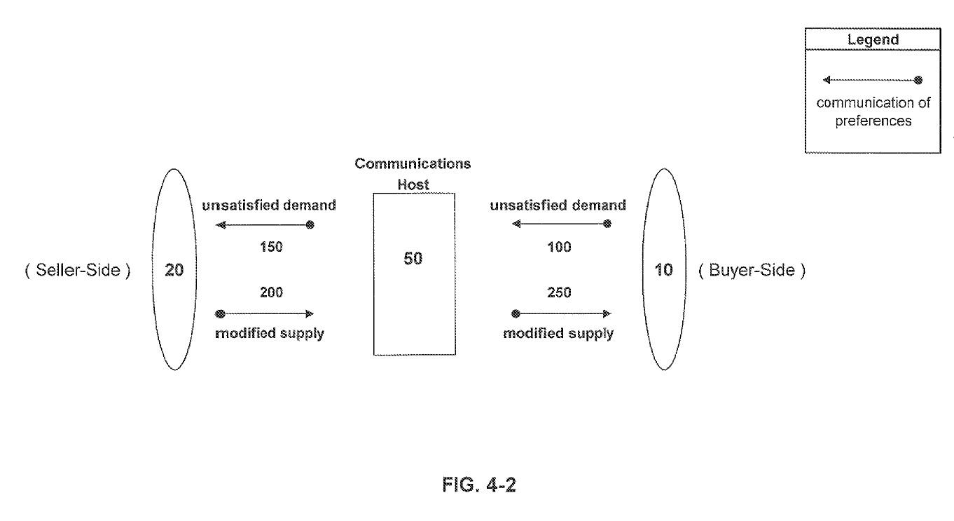

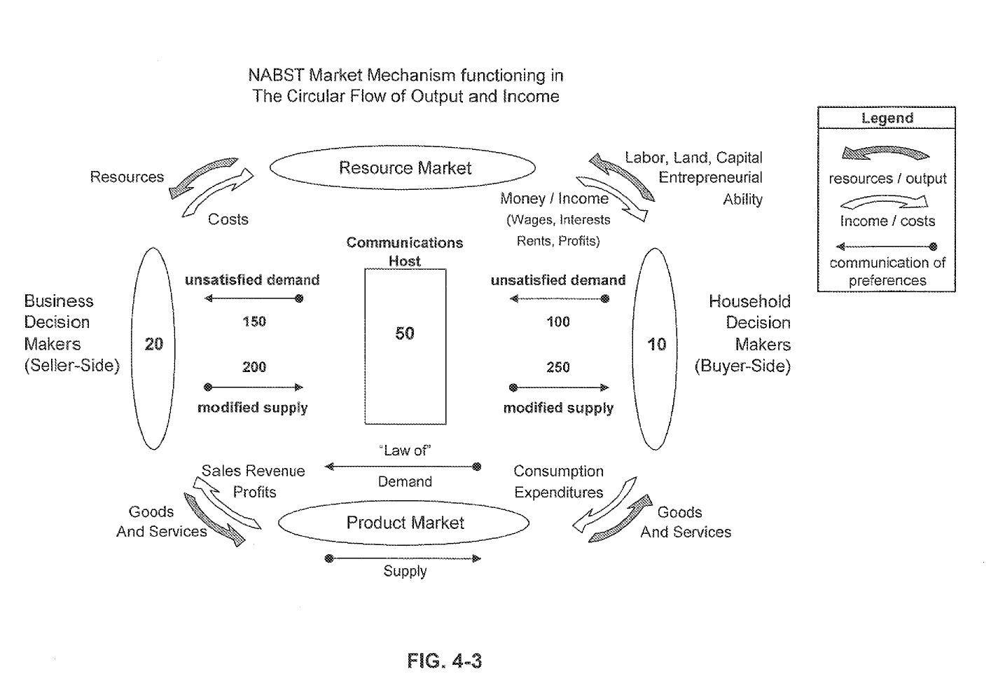

Resource: 12^{th} Edition Economics—McGraw-Hill With reference to FIG. 4-1, prior art concerning “The Circular Flow of Output and Income”. This model implies a complex, interrelated web of decision making and economic activity. The preferences of buyers and sellers are registered on the demand side and the supply side of various product markets. Consumers, unrestrained by government and with incomes from the sale of resources spend their dollars on those goods they are most willing and able to buy. These expenditures are “dollar votes” by which consumers communicate their wants through the demand side of the product market. The problem which exists in this state of technology is the “wall of uncertainty”. This uncertainty results from a lack of buyer demand information communicated to the seller absent from purchase in the product market (unsatisfied demand).

Ultimately buyers and sellers share the common goal of consumption. To improve the desired result, unsatisfied demand should receive an account of modified supply. Interrelationships will not occur by accident or by fiat. Positive organizational mechanisms should be put into place to pursue interrelationships and to ease inherent coordination and communication difficulties in making them work. At the same time technology is creating interrelationships, it is also reducing costs of exploiting them. The ease of communication has increased just as dramatically as its cost has fallen. By using novel ways of interacting, we will find a whole new set of commercial structures to which we can choose to belong.

Targeted promotional advertising of products is more cost effective than mass advertising. Information delivered directly to a consumer who may be interested in a particular product is one way to utilize technology for targeted communication purposes. However, no system is in place that enables consumers to target a particular seller, upon observation of an item of interest, with information concerning an opportunity for exchange that exists. A method which enabled the self-serving consumer to indicate their personal element of demand for a specific product from a particular store, so they would be alerted to modified supply or new promotional information for the desired product from that store, would be highly effective. The seller's analysis of reliable buyer-segmented product demand concerning the consumer they target would minimize uncertainty, eliciting appropriate incentive schemes and attainment of a superior allocative solution. Targeted delivery of modified supply or promotional advertising information to the consumer with protection from unsolicited seller spam in this transaction is very desirable.

The solution has a social base, a technological plan and some basic economic philosophy to coordinate the economic activities of large numbers of individuals and businesses with Ready to Implement Technology (RIT). The NABST Market Mechanism (Notification And Bargaining Sales Tool) is an elaborate communication system through which numerous individual free choices of buyers and sellers are recorded, summarized and properly balanced against one another. The NABST ultimately serves as a mechanism for enhancing economic communication and exchange. A new buyer approach improves access to a seller's promotional information while forward integration of price research enhances buyer convenience. The cost of a product includes not only financial costs but also time and convenience costs. The costs of time reflect the opportunity costs of using it elsewhere. Buyer value results from lowering any of these costs. A new seller approach improves access to the buyer while every point of contact represents an opportunity to influence the perception of a firm and imparts value.

### BRIEF SUMMARY OF THE INVENTION

Potential buyers communicate the store of product observation and a product of interest to a communications host. The store and product information, together with a return address for responsive communications concerning the store and product, is stored in a database. A seller interested in demand at their establishment could access the database and retrieve aggregate buyer-segmented product demand information for the consumer they target. The seller is able to design incentive schemes more effectively and communicate promotional information to the potential buyer via the communications host.

In this method, there is communication concerning an exchange opportunity between two parties. Supply does sellers little good unless it can be matched with some corresponding demand. Unsatisfied consumer demand information is observable and communicated to the proper seller. New promotion information is properly targeted back to the potential buyer, who in effect is requesting to be notified of modified supply or new promotion information for the product under consideration.

### BRIEF DESCRIPTION OF THE SEVERAL VIEWS OF THE DRAWING

### Unsatisfied Demand Information

FIG. 1-0 depicts the (A) code and (B) image which may comprise the “NAB-IT ID”.

FIG. 1-1 depicts a buyer-side observation of a seller-side solicitation which includes instructions for submitting unsatisfied demand information to the host (NABST) for monitoring.

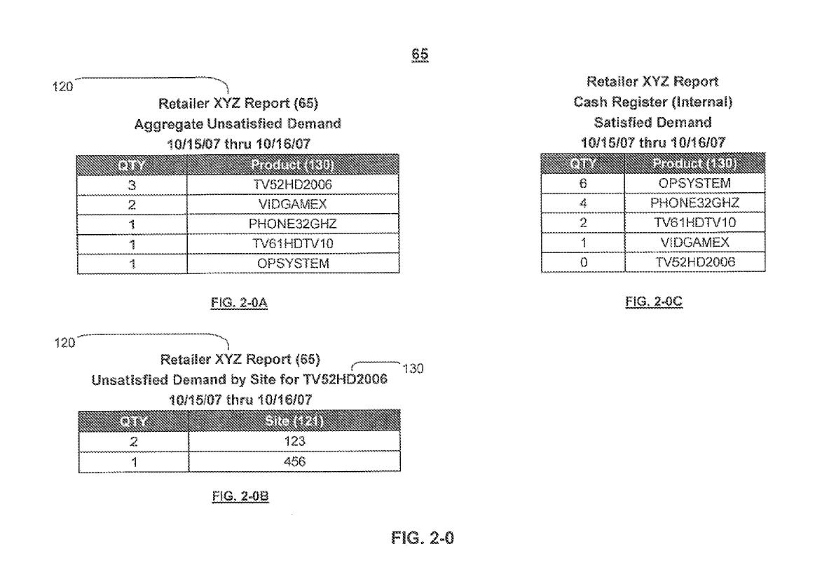

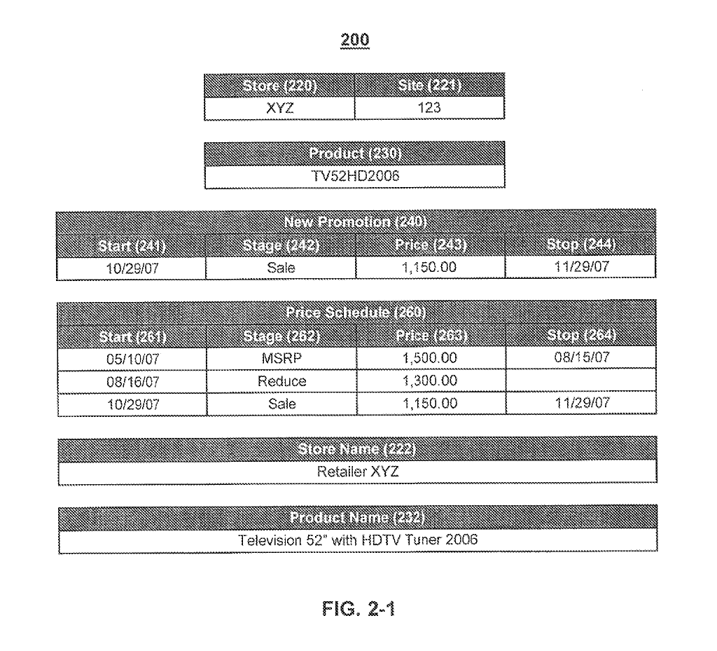

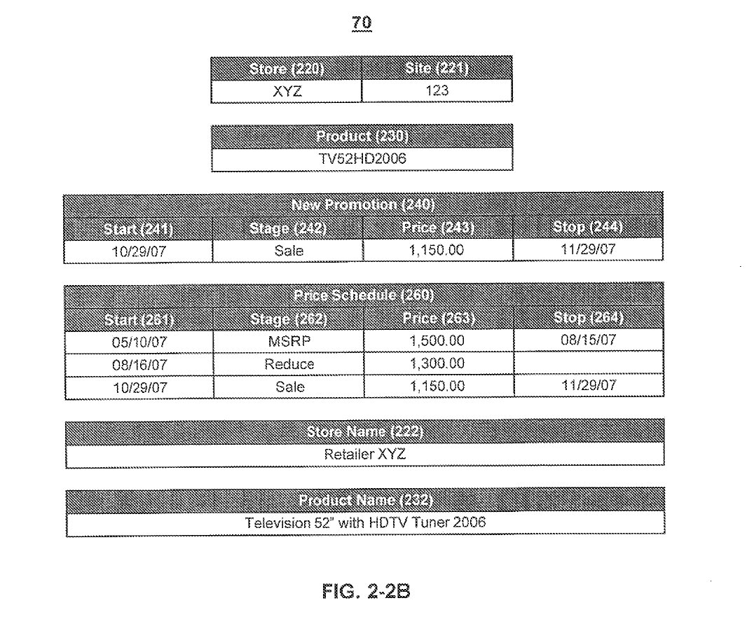

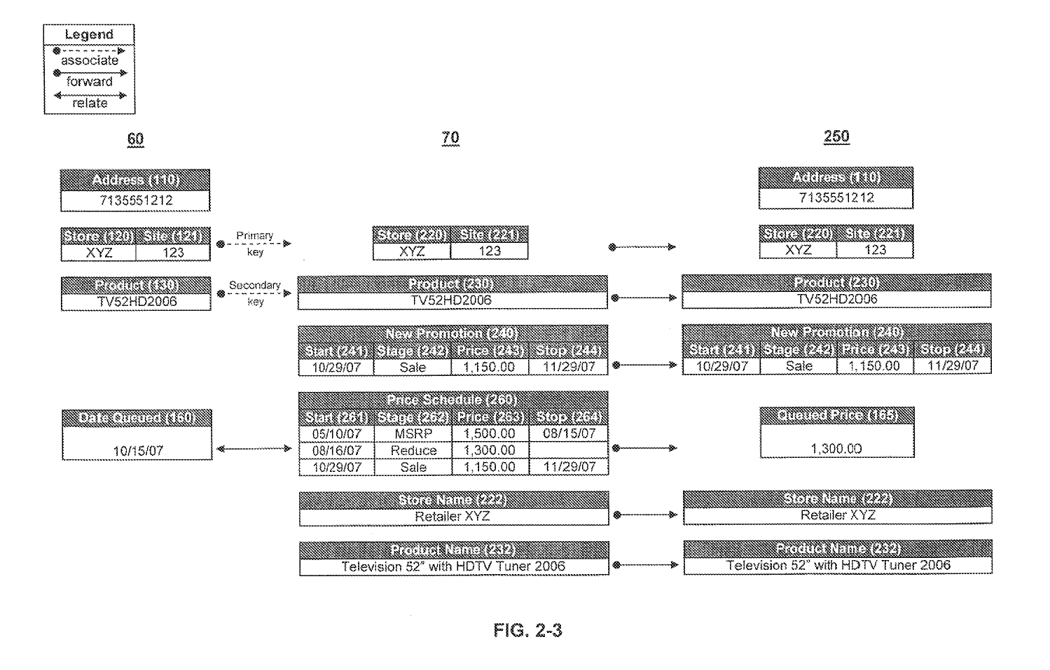

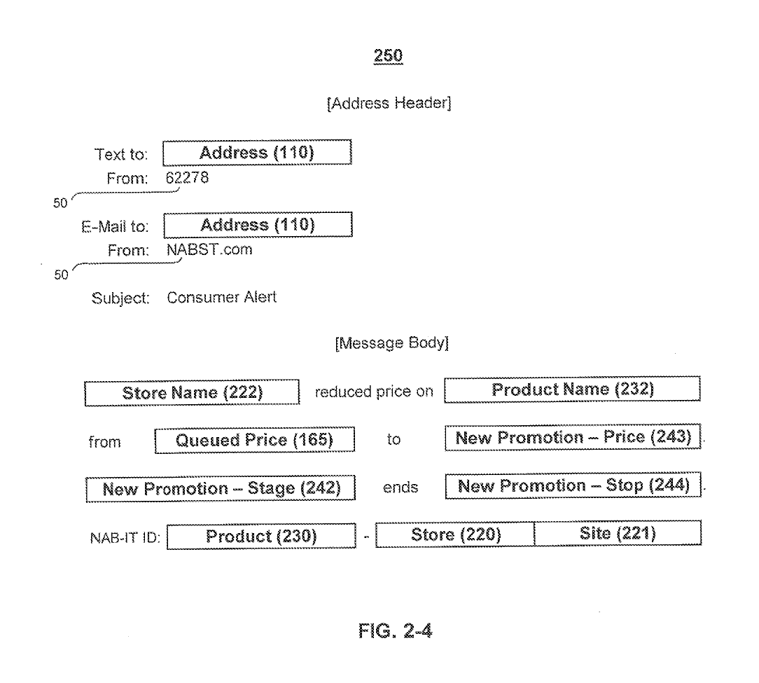

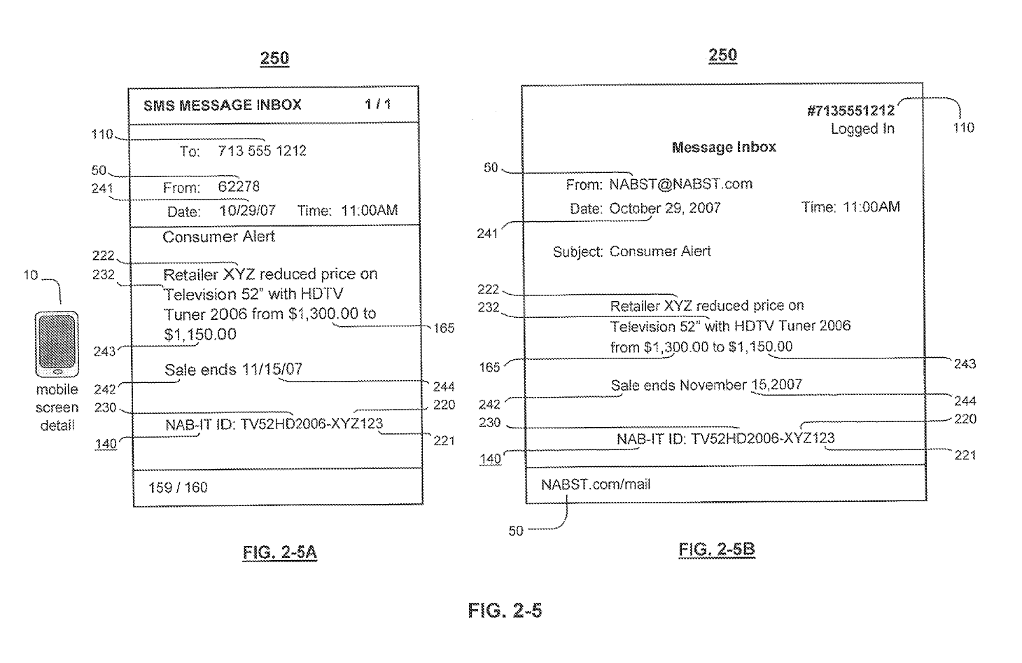

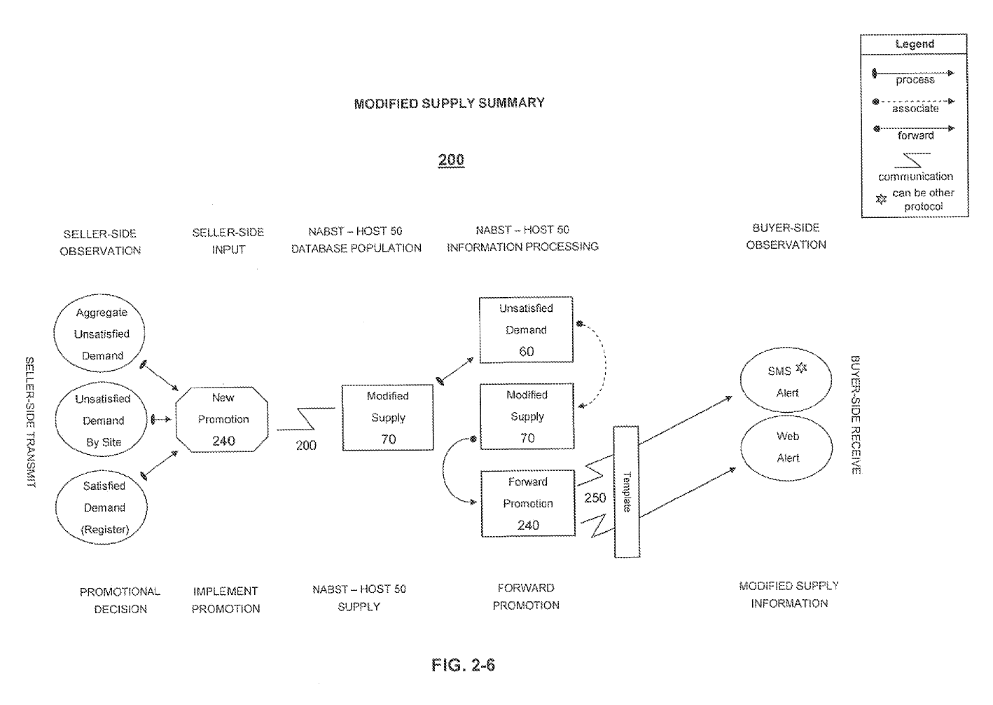

FIG. 1-2 depicts buyer-side input of unsatisfied demand using a cellular device enabled with (A) MMS protocol or (B) SMS protocol.

FIG. 1-3 depicts host decoding and translation of “NAB-IT ID” prompting buyer-side confirmation of unsatisfied demand for data integrity.

FIG. 1-4 depicts a host request for buyer-side input confirming unsatisfied demand using (A) SMS protocol or (B) web-enabled device.

FIG. 1-5 depicts host database population of confirmed unsatisfied demand comprising at least return address information, store ID information and product ID information.

FIG. 1-6 depicts (A) host information processing for seller-side import and a seller-side observation of (B) aggregate unsatisfied demand or (C) regional unsatisfied demand for a particular product.

FIG. 1-7 depicts process of unsatisfied demand information from a potential buyer to a seller in accordance with an embodiment of the invention. (Unsatisfied Demand Summary)

### Modified Supply Information

FIG. 2-0 depicts a seller-side observation of (A) aggregate unsatisfied demand, (B) regional unsatisfied demand for a particular product and (C) satisfied demand.

FIG. 2-1 depicts a seller-side data management system with a scheduled implementation of a new promotion.

FIG. 2-2 depicts (B) host database population of modified supply comprising at least store ID information, product ID information and new promotion information.

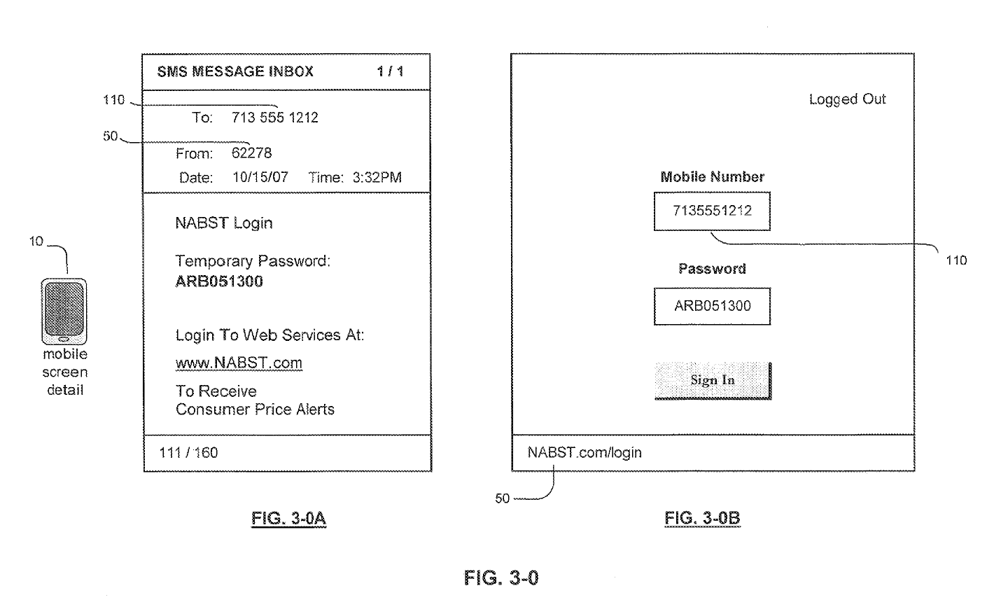

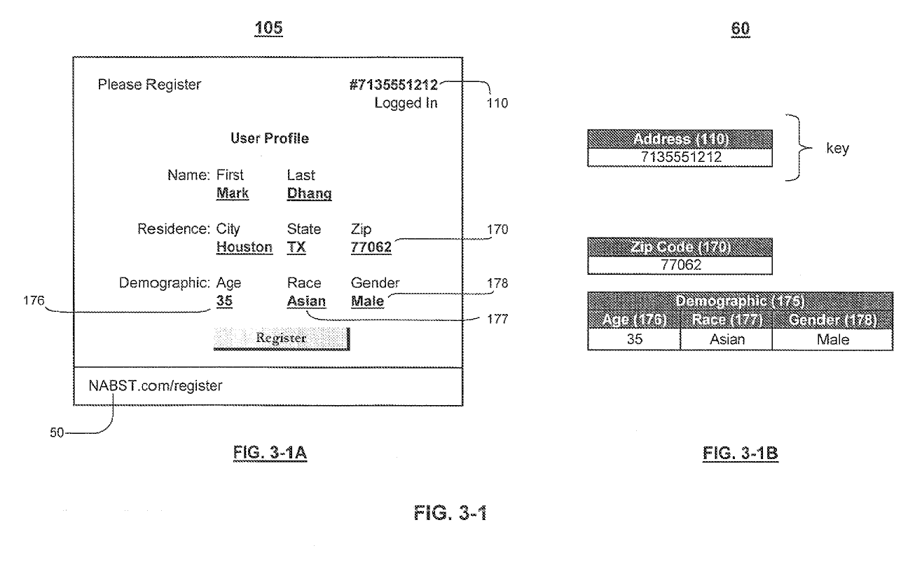

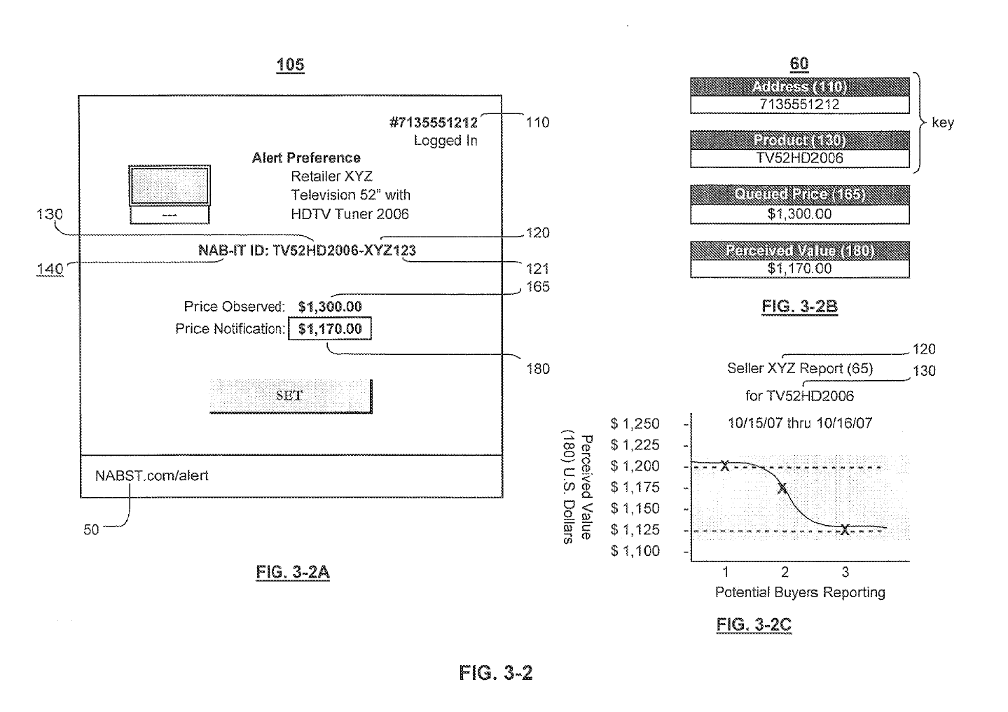

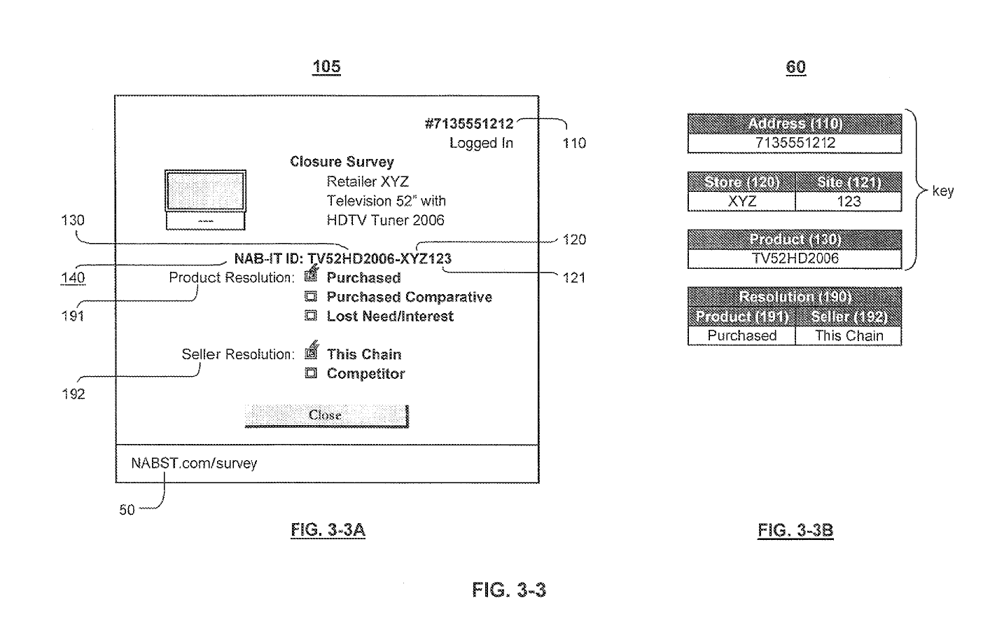

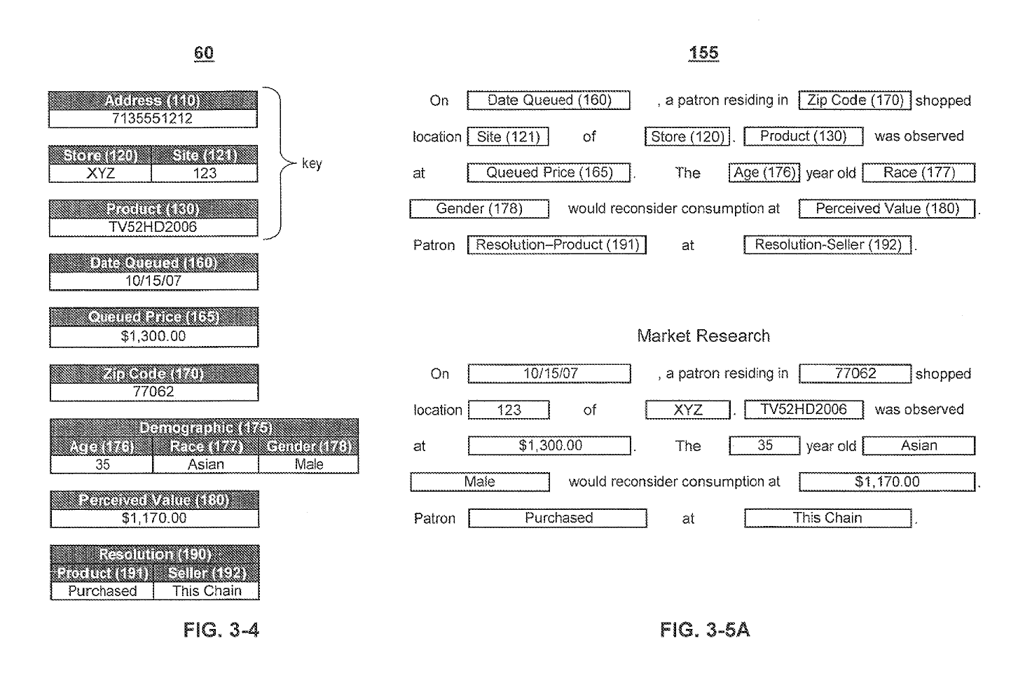

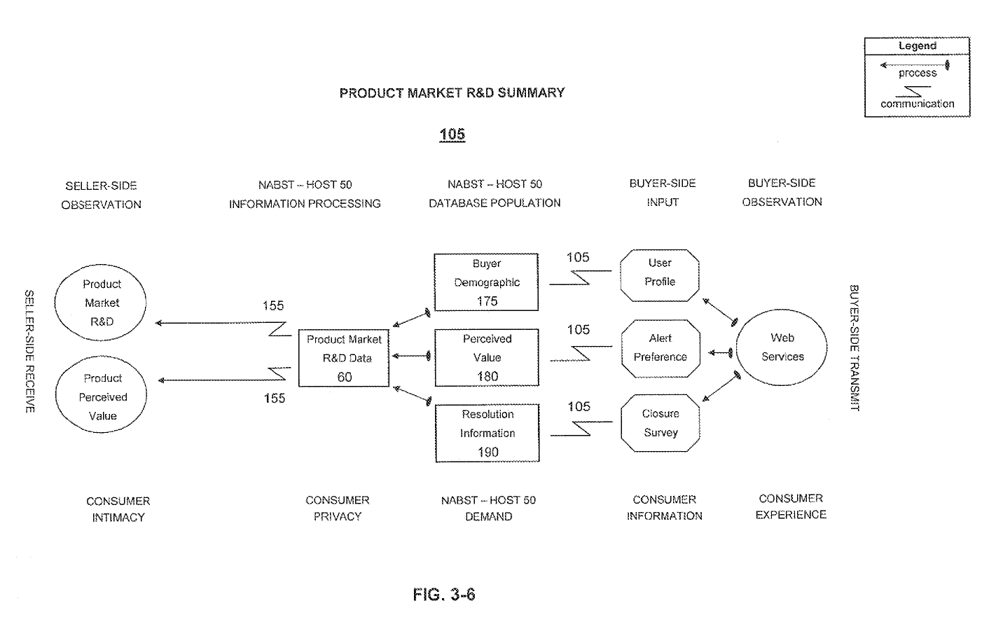

FIG. 2-3 depicts record of unsatisfied demand associated to record of modified supply in the host (NABST) database and new promotion information forwarded to the potential buyer as a responsive communication.

FIG. 2-4 depicts population of new promotion information into a consumer alert template.

FIG. 2-5 depicts a buyer-side observation of modified supply information in a consumer alert received on (A) cellular device in SMS protocol and/or (B) web-enabled device.

FIG. 2-6 depicts process of modified supply information from a seller to a potential buyer in accordance with an embodiment of the invention. (Modified Supply Summary)

### Product Market R&D Information

FIG. 3-0 depicts a buyer-side observation of (A) temporary password for web services and (B) login on a web-enabled device.

FIG. 3-1 depicts buyer-side input of (A) user profile information and (B) database record of buyer demographic as populated by the user profile.

FIG. 3-2 depicts buyer-side input of (A) preference information indicating criteria for SMS alert (B) database record of buyer perceived value as populated by the SMS alert preference and (C) aggregate perceived value for a particular product.

FIG. 3-3 depicts buyer-side input of (A) closure survey information and (B) database record of buyer resolution as populated by the closure survey.

FIG. 3-4 depicts host information processing into a record of product market R&D by merging unsatisfied demand with demographic information, perceived value information and resolution information.

FIG. 3-5 depicts seller-side observation of (A) buyer-segmented product market R&D information.

FIG. 3-6 depicts process of product market R&D information from a potential buyer to a seller in accordance with an embodiment of the invention. (Product Market R&D Summary)

### NABST Market Mechanism

FIG. 4-0 depicts an electronically implemented targeted communications method in accordance with an embodiment of the Invention.

FIG. 4-1 depicts prior art information concerning resource flow between business and consumers with communication of demand through purchase in the product market.

FIG. 4-2 depicts flow of unsatisfied demand information and modified supply information in accordance with an embodiment of the invention. (FRONT PAGE VIEW)

FIG. 4-3 depicts how implementation of the invention enhances economic communication and exchange in the buyer/seller relationship.

### Exemplary Environment

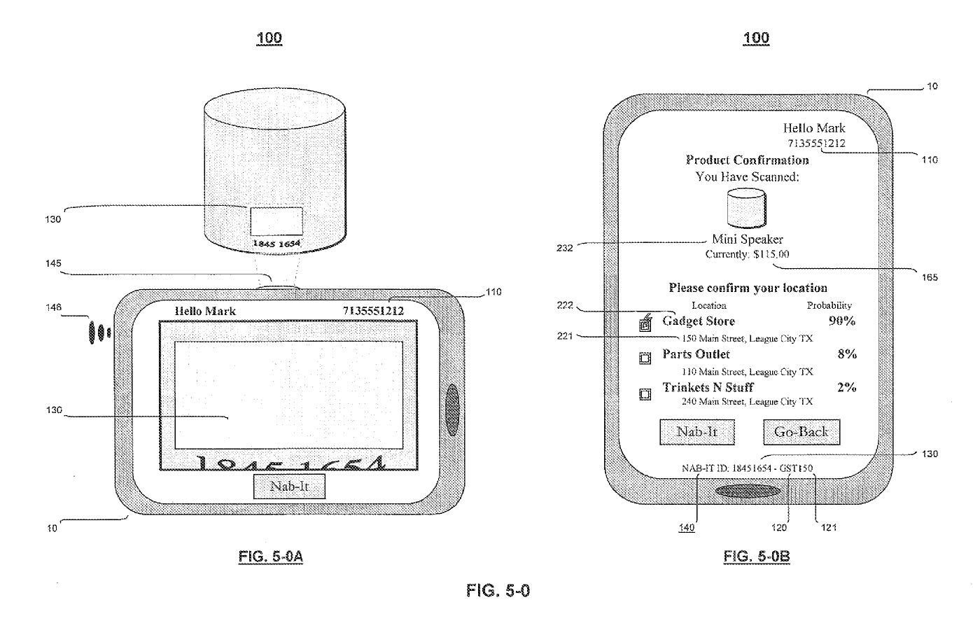

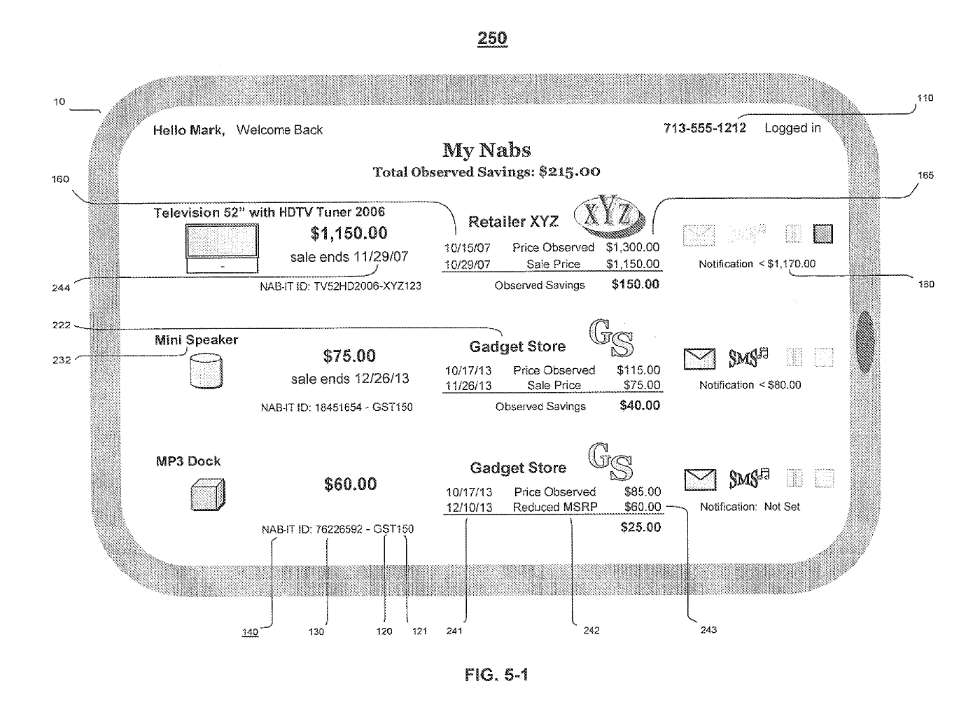

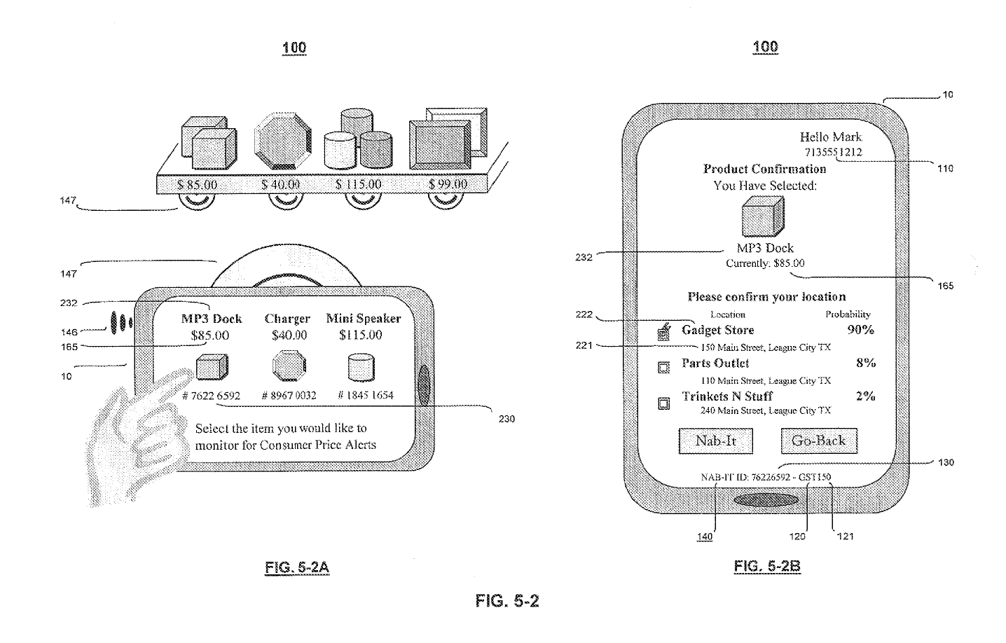

FIG. 5-0 depicts an environment utilizing (A) imaging and location data on the buyer device (B) verified using human discernment

FIG. 5-1 depicts a buyer-side personal product index

FIG. 5-2 depicts an environment utilizing (A) near field communications (NFC) and location data on the buyer device (B) verified using human discernment

### REFERENCE NUMERALS

buyer-side user input/output device 10
seller-side user input/output device 20
host computer system 50
operably associated computer instructions 56
database record 60
database report 65
database record 70
first electronic communications 100
third electronic communications 105
return address information 110
store ID information 120
store ID-site information 121
product ID information 130
code (NAB-IT ID) 140
imaging 145
location data 146
near field communications 147
communication 150
communication 155
date queued information 160
queued price 165
zip code information 170
demographic information 175
demographic-age 176
demographic-race 177
demographic-gender 178
perceived value information 180
resolution information 190
product resolution 191
seller resolution 192
second electronic communications 200
store ID information 220
store ID-site information 221
store name information 222
product ID information 230
product name information 232
new promotion information 240
new promotion-start 241
new promotion-stage 242
new promotion-price 243
new promotion-stop 244
communication 250
price schedule information 260
price schedule-start 261
price schedule-stage 262
price schedule-price 263
price schedule-stop 264

### GLOSSARY OF TERMS

aggregate product demand—cumulative demand for goods of a business during a specific period

code—a scheme for identifying at least the particular store of observation and a specific product of interest; labeled as “NAB-IT ID”

database—a compilation of information arranged in a systematic way and offering means of finding specific elements it contains by electronic means

date queued information—concerning the date and optionally time a product was observed and queued for monitoring

demand—the intensity of consumer pressure on the cost of goods

demographic information—concerning the statistical characteristics of a consumer

first electronic communications—concerning a buyer-side request for new promotional information about a specific product from a particular store

host computer system—a programmable electronic device that can at least receive, store, request, retrieve, process and transmit data

market—a geographic area or demographic segment considered as a place of demand for particular goods

messaging protocols—a set of conventions for formatting data in an electronic communication

new promotion information—concerning a new discount or purchasing incentive for the consumer's product of interest

perceived value information—concerning the potential buyer's assessment of the product of interest

potential buyers—consumers unwilling to pay the existing market price for goods although they still desire to obtain the product

price schedule information—concerning the date and optionally time information for past and present stages of product pricing

product ID information—used to establish a specific product of consumer desire available for purchase

queued price information—relating date queued information to price schedule information to establish a queued price reference

receiving—acquiring or controlling

resolution information—concerning if a specific product was purchased and from a particular seller

return address information—representative of where the potential buyer would like to receive or associate responsive communications concerning a store and product

satisfied demand—the intensity of pressure from consumer purchase of a product on the cost of those goods

second electronic communications—concerning a seller-side responsive communication including new promotional information about a specific product in a particular store

store ID information—used to establish the particular store the product of interest was observed and available for consumer purchase

supply—goods offered for purchase at a particular time or price

targeted promotional information—a responsive communication to present (merchandise) for buyer acceptance by drawing attention to discounting or other purchasing incentives

third electronic communications—concerning buyer-side additional information

transmit—to send or transfer from one place to another

unsatisfied demand—the intensity of consumer pressure absent from purchase on the cost of goods in the product market

web-enabled—to give ability to access the internet network

### DETAILED DESCRIPTION

With reference to FIG. 4-0, one embodiment of the invention provides an electronically implemented targeted communications method carried out by a host computer system 50. The host computer can be viewed as having a function side 50-demand for processing communications concerning a potential buyer of a product and a function side 50-supply for processing communications concerning the seller of the product. With reference to FIG. 1-2, the host computer 50-demand receives a plurality of first electronic communications 100 from buyer-side users. Each of the plurality of first electronic communications containing at least return address information 110 for a potential buyer, store ID information 120 and product ID information 130. With reference to FIG. 1-5, database records 60 of first electronic communications are formed in the host computer comprising the return address information for a plurality of addresses, store ID information 120 for a plurality of stores and product ID information 130 for a plurality of products. With reference to FIG. 1-6, the host computer may transmit aggregate information in communication 150 to the store 120 recorded with the product 130 in the database. The return address information is preferably excluded to meet consumer expectations of privacy. With reference to FIG. 1-7, the process of unsatisfied demand information in communications 100 can be summarized from a buyer to the seller in accordance With an embodiment of the invention. With reference to FIG. 2-1, the host computer 50-supply then receives a plurality of second electronic communications 200 containing at least store ID information 220 for the seller, product ID information 230 and new promotion information 240. With reference to FIG. 2-2B, a database record 70 of second electronic communications is then formed in the host computer comprising the store ID information 220 for a plurality of stores, product ID information 230 for a plurality of products and new promotion information for a plurality of promotions. With reference to FIG. 2-3, the host computer associates database records 60 of first electronic communications and database records 70 of second electronic communications containing the same store ID information and product ID information and forwards new promotion information in communication 250 to the return address 110 of buyer-side users recorded with the same store 120 and product 130 in the database. With reference to FIG. 2-6, the process of modified supply information in communications 200, can be summarized from a seller to the buyer in accordance with an embodiment of the invention.

With reference to FIG. 3-1, FIG. 3-2 and FIG. 3-3, the host computer 50-demand receives a plurality of third electronic communications 105 containing return address information 110 for a potential buyer, store ID information 120 and product ID information 130 along with demographic information 175 or perceived value information 180 or resolution information 190. With reference to FIG. 3-4, the host computer merges third electronic communications into database records 60 of first electronic communications 100 containing the same return address, information, store ID information 120 and product ID information 130. With reference to FIG. 3-5A, the host computer system 50 transmits aggregate information in communication 155 to the store 120 recorded with the same product 130 in the database. With reference to FIG. 3-6, the process of product market R&D information in communications 105 can be summarized from a buyer to the seller in accordance with an embodiment of the invention.

With reference to FIG. 4-0, in this method there is communication concerning an exchange opportunity between two parties. Supply does sellers little good unless it can be matched with some corresponding demand. Unsatisfied consumer demand information is observable and communicated to the proper seller. New promotion information is properly targeted back to the potential buyer, who in effect is requesting to be notified of modified supply or new promotion information for the product under consideration from that seller.

### Operation

With reference to FIG. 1-2, because text messaging is becoming increasingly popular, it is contemplated that the plurality of first electronic communications 100 concerning unsatisfied product 130 demand may be transmitted in (A) MMS protocol or (B) SMS protocol. With reference to FIG. 2-5A, new promotion information 240 concerning modified product supply in communication 250 may be transmitted to the return address 110 recorded with the same store 120 and product 130 in the database in SMS protocol. As technology progresses and becomes widely available, it is contemplated communications 100 and communications 250 may be transmitted with a preferred image in MMS, EMS and other messaging protocols.

With reference to FIG. 1-5, the plurality of first electronic communications 100 from a potential buyer preferably contains at least return address information 110 representative of where the potential buyer would like to receive or associate responsive communications concerning a store and product, store site information 121 (store ID-site) concerning the specific location the product was observed, product ID information 130 (generally will comprise a product code selected from the group consisting of SKU, UPC, EAN, GTIN, VIN, MLS# and inventory numbers) and date queued information 160 concerning the date and optionally time the first electronic communication was transmitted to the host computer 50-demand. The host computer system 50 forms database records 60 comprised of this information and with reference to FIG. 1-6, generates database reports 65 of aggregate information and transmits the reports to the associated seller in communication 150 and/or permits the seller to access the database information for analysis of aggregate product demand.

With reference to FIG. 2-2B, the plurality of second electronic communications 200 from the seller preferably contains at least store site information 221 (store ID-site) concerning the specific location the product is available, product ID information 230 (generally will comprise a product code selected from the group consisting of SKU, UPC, EAN, GTIN, VIN, MLS# and inventory numbers), new promotion information 240 (indicating promotion start 241, stage 242, price 243, and stop 244) concerning the product, price schedule information 260 (indicating price schedule start 261, stage 262, price 263, and stop 264) for past and present stages of product pricing, store name information 222 corresponding to the store ID information 220 and product name information 232 corresponding to the product ID information 230. The host computer system 50 forms database records 70 comprised of this information and with reference to FIG. 2-3, relates date queued information 160 to price schedule information 260, store ID information 120 to store name information 222 and product ID information 130 to product name information 232. With reference to FIG. 2-4, the host computer populates the consumer alert template with new promotion information, related price schedule information, store name information and product name information. With reference to FIG. 2-5, the host computer transmits the consumer alert in communication 250 to the return address 110 recorded with the same store 120 and product 130 in the database.

With reference to FIG. 3-4, the plurality of third electronic communications 105 from a potential buyer preferably contains return address information 110, store ID information 120 and product ID information 130 along with zip code information 170 concerning the place the potential buyer resides, demographic information 175 concerning the age 176, race 177 and gender 178 of the potential buyer, perceived value information 180 concerning the potential buyer's assessment of the product in demand and resolution information 190 concerning the outcome of the buyer-side/seller-side communication for the store and product. The host computer system 50 merges the plurality of third electronic communications into database records 60 of first electronic communications containing the same return address information, store ID information 120 and product ID information 130 and with reference to FIG. 3-5A, generates database reports 65 of aggregate information and transmits the reports to the associated seller in communication 155 and/or permits the seller to access the database information for analysis of aggregate product market R&D.

With reference to prior art in FIG. 4-1, concerning The Circular Flow of Output and Income. This model implies a complex interrelated web of decision making and economic activity. The preferences of buyers and sellers are registered on the demand and supply side of various product markets. Consumers, unrestrained by government and with incomes from the sale of resources spend their dollars on those goods they are most willing and able to buy. These expenditures are “dollar votes” by which consumers communicate their wants through the demand side of the product market. The dollar votes of consumers play a key role in determining what products a profit seeking business will supply and at what cost. The problem which exists in this state of technology is the “wall of uncertainty”. This uncertainty results from a lack of buyer demand information communicated to the seller absent from purchase in the product market (unsatisfied demand). With reference to FIG. 4-2, it should be noted, however, the method may be operable from the consumers point of view without knowledge of aggregate demand information being communicated to the sellers, Additionally, it is preferred the seller communicate information of modified product supply to prospective buyers indirectly by means of the host computer. This method will protect the buyer-side users from unsolicited seller-side spam. With reference to FIG. 4-3, we examine a hypothetical model making explicit use of the demand and supply components of microeconomics. An illustration which explicitly embodies the formal components of economical analysis. The model explored emphasizes the interrelatedness of the many decision makers who comprise the purely competitive economy. It is an object of this embodiment to provide an alternative method of economic communication absent from purchase.

The use of a communication method for unsatisfied demand and modified supply information undergoing examination and systematic arrangement by a preferred NABST (Notification And Bargaining Sales Tool) will streamline the process of economic exchange. Generally any given product will be distributed to consumers on the basis of their ability and willingness to pay the existing market price for it. Those buyers who are able and willing to pay that price will get a unit of the product; those who are not, will not. When reluctant consumers normally disengage with passing desire, the NABST Market Mechanism engages them to remain active with their unsatisfied demand. Where economic communication heretofore has typically been implied, economic communication hereafter involves meaningful messages between economic participants. For example, with reference to FIG. 1-1, a buyer-side user upon seeing an item of interest may follow posted instructions to provide in the outgoing message a preferred code containing store and product information concerning an opportunity for exchange that exist. The potential buyer is requesting and consenting to future communications relating to that store and product. The NABST identifies the message or data export received from either participant to be a notification of unsatisfied demand or modified supply and is recorded for reference, creating the functional sales tool. With reference to FIG. 2-0A and FIG. 2-0B, a buyer-side user of the NABST would effectively communicate their personal element of unsatisfied demand for a particular product to targeted seller-side users of the system, generally selected from dealers, retail stores and agents representing property. With reference to FIG. 2-5, a seller-side user of the NABST would effectively communicate modified supply or new promotional messages for a desired product to targeted buyer-side users of the system. The NABST provides consumer protection from unsolicited seller spam in this transaction.

### Buyer-Side Devices

With reference to FIG. 1-2, for efficiency, it is contemplated the method utilizes hand-held devices, PDAs and cellular phones with imaging 145 and/or messaging capabilities as the buyer-side user input/output device 10 and the return address 110 may comprise the phone number. The buyer-side user preferably transmits their phone number and a preferred code 140 known as the “NAB-IT ID” to a host computer system 50 by means of a message service protocol. With reference to FIG. 1-0B, for efficiency and elimination of keystroke errors, it is contemplated that the NAB-IT ID may comprise a preferred image incorporating OCR (Optical Character Recognition) labeling of preferred fields. By utilizing the imaging device and cropping the image to effectively capture the information, the buyer-side user is eliminating the manual reproduction of the NAB-IT ID. No additional software is required on the buyer-side user input/output device for interpretation or translation of the information. The image is delivered to the NABST by means of MMS protocol or data export. The computer instructions associated with the host computer system are further capable of deriving store ID-code information 120, store ID-site information 121 and product ID information 130 using OCR capabilities. Geometric symbols may frame the extremities of the image to help identify and correct distorted captures. Unusable images are promptly identified by the NABST and a message is delivered to the buyer-side user input/output device requesting another submission of the NAB-IT ID to the system. With reference to FIG. 2-5, in time, the host computer preferably transmits new promotion information 240 to the buyer-side user input/output device by means of a text message.

As technology progresses and becomes more widely available, for efficiency, it is contemplated the method will utilize hand-held devices, PDAs and cellular phones with additional RFID (Radio Frequency ID) capabilities on the buyer-side user input/output device 10. Additional software may be required on the device to derive store ID-code information 120, store ID-site information 121 and product ID information 130 required to compose the NAB-IT ID. The information is delivered to the NABST by means of SMS protocol or data export.

### Data Integrity

Because the absence of reliable information in the system tends to prevent the attainment of a superior allocative solution, the NABST verifies unsatisfied buyer-side demand for data integrity. With reference to FIG. 1-3, the host computer system decodes the NAB-IT ID information and translates this information to a corresponding store name 222 and product name 232 for buyer-side confirmation of unsatisfied demand. With reference to FIG. 3-0, upon a buyer-side user's initial participation from a particular number, a security layer may be observed for registration of web services. A temporary password could be transmitted to the return address 110 of the buyer-side user input/output device 10 in SMS protocol. With reference to FIG. 1-4, once registered with web services the store 222/product 232 relationship is verified using buyer-side input in (A) SMS protocol or (B) on a web-enabled device. Confirmed unsatisfied demand information is then electronically recorded as an element of the buyer-side user's personal product index. The product is then monitored by the individual and/or host, along with the rest of the products in their index, for modified supply coming into the NABST from seller-side users. For example; reduced MSRP, sale price, rebates, discontinuation, financing and other incentives. The host computer system utilizes this information to transmit new promotions 240 by text message or electronic mail (E-Mail) to the buyer-side user input/output device as a responsive communication, encouraging them to reevaluate their potential consumption of the desired product.

With reference to FIG. 1-5, the communication method preferably comprises means for transmitting additional demand information from the buyer-side user input/output device 10, for example, date queued information 160 concerning the date and optionally time the product was queued for monitoring. With reference to FIG. 2-2B, the communication transmitted from the seller-side user input/output device 20 preferably also contains additional supply information, for example, price schedule information 260 including date and optionally time information for past and present stages of product pricing, store name information 222 concerning the store outlet name and product name information 232 concerning the product label. The computer instructions operably associated with the host computer system 50 are capable of relating date queued information to price schedule information to establish a queued price 165 reference relative to the new promotion 240. Additionally, product demand is more elastic the longer the time period under consideration. Date and time information in the database could be used by sellers to weed out stale leads.

### Product Market Research

It is well known to those familiar with economics, that geographic location may be important directly as a cost driver. The location of the buyer's primary dwelling emerges as the most important geographic segmentation variable even though the buyer may use the product somewhere else. With reference to FIG. 3-1, the communication method preferably comprises means for transmitting the buyer-side user zip code information 170 to the NABST during a user profile procedure. Where reports 65 are to be generated, the computer instructions associated with the host computer system 50 are preferably capable of sorting unsatisfied demand information based on buyer-side user zip code and transmit the report to the seller-side user having the location, or marketing power in the location. Buyer demographic can be a proxy for the desired product attributes, price sensitivity and other signaling criteria. Additionally, the communication method preferably comprises means for transmitting the buyer-side user demographic information 175 to the NABST during the user profile procedure. For example, some key factors may include: age 176 group, race 177, gender 178, household size, decision maker and occupation of the potential buyer. Where reports are to be generated, the computer instructions associated with the host computer system are preferably further capable of reporting demographic breakdown of unsatisfied product 130 demand. Potential buyers of a product not currently purchasing may also constitute a buyer segment.

A firm or household does not purchase a product; individual decision makers do. Both actual values and signals of value are assessed and interpreted by these decision makers. A purchase criterion is in meeting perceived value for the buyer. With reference to FIG. 3-2, the communication method preferably comprises means for transmitting buyer-side perceived value information 180 from the buyer-side user input/output device 10. Or alternatively, perceived value information could be transmitted to the NABST during an SMS alert preference procedure. Where reports 65 are to be generated, the computer instructions associated with the host computer system 50 are preferably capable of charting aggregate perceived value information and transmitting the report to the seller-side user whose potential buyers are reflected in the report. The competitive firm does not have a price policy; that is, the ability to freely adjust price. Rather, the firm can merely adjust to the socially optimal price. The competitive seller is a price taker rather than a price maker.

Evidence concerning the economic effects of promotional advertising is mixed because studies are plagued by data problems and difficulties in determining cause and effect. With reference to FIG. 3-3, the communication method preferably comprises means for transmitting if a particular product was purchased and from which seller. The buyer-side user resolution information 190 could be transmitted to the NABST during a seller resolution 192/product resolution 191 closure survey procedure. With reference to FIG. 3-4, the computer instructions associated with the host computer system 50 are preferably capable of merging the communications for a particular buyer/seller/product relationship into records 60 of buyer-segmented product market R&D for seller-side analysis. With reference to FIG. 3-5A, simultaneous benefits include lower cost of marketing research and lower marketing overhead for acquiring equivalent information.

### Exemplary Environments

Because mobile applications are becoming increasingly popular, it is contemplated that software may reside on buyer-side device 10 to enable preferred operations. Machine readable instructions may be installed or reside in hardware to assist with utilizing imaging 145, identifying location data 146, and processing near field communications 147 (NFC) for information that may comprise first electronic communications 100 to host computer system 50. It is contemplated return address information 110 may comprise login credentials, e-mail identification, cellular number(s), or other identifying means to target responsive communications. A plurality of buyer identification may be associated to one account permitting many participation scenarios. It is contemplated store ID information 120 may comprise location data such as GPS information utilizing capabilities on the buyer-side device. It is contemplated product ID information 130 may also be obtained by means of near field communications such as RFID. Identification information may be processed on the buyer device or delivered to the host computer system for interpretation or translation. Information in communications 150 may be exported from the buyer-side device using internet protocol (IP) packets or other electronic delivery means. With reference to FIG. 5-1, the buyer-side device may display activity concerning product(s) in demand from the store(s) of observation preferably including: store name information 222, product name information 232, queued price 165, price schedule information 260 and new promotion information 240. A buyer may not view another buyer's personal product index unless desired products are made public by the buyer's choice, such as a gift registry.

Because aggregate demand data can be observed in “real-time”, a seller can learn which potential buyers they may lose and present timely offers on products enabling consumers to buy. The unsatisfied demand information available to the seller preferably omits return address information 110 such as login credentials, e-mail identification, cellular number(s), or other identifying means. It is contemplated that a seller may receive contact information and agrees to use it for requested promotions only; this method is not preferred since it is an unnecessary risk to a consumer's expectations of privacy. Machine readable instructions may be installed on seller-side device 20 to format information that may comprise second electronic communications 200. This allows the integration of seller data to the host computer system 50 through a variety of data management systems and platforms. The seller-side device preferably exports data in a universal structure such as the delimited format. It is contemplated that the store name information 222 corresponding to store ID information 220 may be provided one time during a seller setup procedure. Product name information 232 corresponding to product ID information 230 may be retrieved from a third-party database as well as directly from the seller. A seller's new promotion(s) 240 are preferably posted directly to the host computer system rather than a procedure with a third-party source of product pricing information. A direct seller transmission improves resource utilization and provides seller responsibility for accuracy of information provided to the potential buyers. It is possible in some instances that future promotions may broadcast in communications 250 prior to the effective start date. It is contemplated as a loyalty reward, a store may target special promotions to “participating individuals” that may not be available to the general public. Generally, promotion information of this nature would not be available in a third-party system.

As is well known in the art, the database structures (for example: buyer profile database, product information database, seller profile database, etc) of the host computer system 50 may be physically connected within the same location, or have one or more structures remotely located in different locations. The buyer profile database may be limited to generic (or anonymous) information that characterize the buyer rather than reference the actual identity. With reference to FIG. 5-0B, because of the improvement in accuracy of popular location capabilities such as GPS, it is contemplated the store ID information 120 and store ID-site information 121 in first electronic communications 100 may be obtained via location data 146. For example, the host computer system may use GPS information to identify business addresses in the immediate proximity. Establishments, such as restaurants, may be omitted when merchandise sought and merchandise offered is not agreeable. Buyers may be presented a list of sellers by probability and the buyer's confirmation continues to dynamically map business boundaries improving the host ability to more readily identify the store and present that seller more prominently in future communications from that approximate location. Date queued information 160 may originate in the host computer system upon receiving first electronic communications and is preferably added to database record 60 concerning product demand. Demographic information 175 may be associated to return address information 110 upon buyer registration. This demographic is preferably associated to all stores and products which the address, or related addresses, has been recorded. It is contemplated that perceived value information 180 may accompany return address information and product ID information 130 alone since the product evaluation is generally independent of the store of observation. Resolution information 190 may accompany return address information and product ID information while seller resolution 192 may apply dynamically. A final product resolution 191 indicating non-purchase can eliminate the specific product from all sellers. Likewise, a final seller resolution indicating purchase from one particular store may eliminate the product from remaining sellers.

### Best Mode Contemplated

### Example 1

For example, with reference to FIG. 5-0A, a buyer-side user upon seeing an item of interest would open a mobile application on the buyer-side user input/output device 10. The software may associate a variety of return address information 110 to the user but generally a unique login will identify the interested consumer. It is contemplated a primary function of the software will utilize imaging 145 capabilities to retrieve product ID information 130 from an image or bar code included on or near product packaging. Simultaneously, the software may utilize GPS capabilities to record location data 146 used to ascertain store ID information 120 and furthermore, store ID-site information 121 which may comprise the NAB-IT ID 140. The information in communications 100 can be exported to the host computer system 50 by means of data packets, preferably over the interne. With reference to FIG. 5-0B, after the data is received, interpreted and translated, there is preferably an additional exchange between the host and the buyer-side user to confirm the store and product using human discernment. This additional step helps to validate the authenticity and accuracy of unsatisfied demand. Aggregate unsatisfied product demand is available in real-time numbers in communications 150 to the store of product observation. When seller analysis of demand inspires modified supply, partner sellers transmit new promotional information 240 to the host computer in communications 200, while non-partner sellers pricing information may be retrieved from an outside source. The host forwards the new promotion in communications 250 to the plurality of return address information associated to that store and product. The mobile application maintains a personal product index for the consumer's products of interest. The buyer-side user may discontinue promotional notifications by indicating whether or not a product was purchased, and if so, from which seller. At present I believe that this embodiment operates most efficiently, but the other embodiments are also satisfactory.

### Best Mode Contemplated

### Example 2

For example, with reference to FIG. 5-2, a buyer-side user upon seeing an item of interest may utilize a buyer-side user input/output device 10 to execute one or more programs (e.g. hardware applications, web browser or specified communication software) to permit use of the host services. The program may associate a variety of return address information 110 to the user but generally a unique login will identify the interested consumer. It is contemplated a function of the program will utilize near field communication 147 capabilities such as RFID to retrieve store ID and/or product ID information 130 from a transmitter placed in the immediate proximity of the product. The device can display an augmented reality with product name 232 and current pricing overlying the product display. The sensitivity of the device's receiver can be adjusted to reduce interference from adjacent products. Duplicate signals are filtered, centralized, and presented for shopper selection. Simultaneously, the software may utilize GPS capabilities to record location data 146 used to ascertain store ID information 120 and furthermore, store ID-site information 121 which may comprise the NAB-IT ID 140. The information can be exported to the host computer system 50 by means of data packets, preferably over the internet. After the data is received, interpreted and translated, there is preferably an additional exchange between the host and the buyer-side user to confirm the store and product. Aggregate unsatisfied product demand is available in real-time numbers to the store of product observation. When seller analysis of demand inspires modified supply, partner sellers transmit new promotional information 240 to the host computer while non-partner sellers pricing information may be retrieved from an outside source. The host forwards the new promotion to the plurality of return address information associated to that store and product. It is contemplated a buyer may receive new promotions from the host indirectly by opting for notification through partner sites which the potential buyer may frequent, for example, social media. Using login credentials of a partner site is becoming increasingly popular in targeted advertising strategies. The host maintains a personal product index for the consumer's products of desire which may be accessed through several mediums. The buyer-side user may discontinue notifications by indicating whether or not a product was purchased, and if so, from which seller.

### CONCLUSION, RAMIFICATIONS AND SCOPE

If society registers votes for consumer goods, individual producers and resource suppliers can only adjust to the wishes of buyers as tabulated and communicated by the market system. In communicating between entities with messaging enabled devices, the computer networks have as their job to enable the information space and perform administration. It makes more sense to also bring computers more into the action, to put their analytical power to work in translation, making sense of the vast content. The NABST connects massive data sets allowing statistical algorithms to find economic patterns with unprecedented fidelity. Incoming communications from buyer-side users are preferably analyzed using seller provided criteria, either by seller-side users after retrieval of the necessary unsatisfied demand data from the NABST or in the host computer system with reports generated and transmitted to the seller-side user input/output device associated with such demand. For example, the analysis can summarize unsatisfied product demand with preferential emphasis in various areas such as: (1) identification of product demand by geographic region or store site, (2) identification of product demand by buyer demographic, (3) resolution of buyer/seller communication regarding a product in demand, (4) identification of a potential buyer's perceived value for a product in demand, (5) relationship of product demand to guide equilibrium supply and equilibrium pricing, (6) identification of potential supply chain management issues concerning future consumption of a particular product. Analysis of unsatisfied demand and modified supply information can be used to trace interactions between various product markets. With reference to FIG. 2-0C, where opportunity to stimulate consumption is identified, new promotion information is exported from the seller-side user input/output device to the host computer to implement the new promotion. It is contemplated that in time, with significant accumulation of statistical data concerning buyer-segmented cause and effect in a particular product market. The host will provide services which factor in numbered units of available seller supply in addition to all R&D variables present in the current environment of demand to guide in the rationing function of equilibrium product supply and pricing.

It is well known to those familiar with commerce that satisfying buyer needs is at the core of success in any business endeavor. A firm can differentiate itself by satisfying buyer needs better than its competitors. Information may be a mechanism through which a firm can increase its share of the market and strengthen consumer loyalty to its particular product. The improved communication method can be implemented for various business industries. In addition to retail, some sectors that are to be targeted include motor vehicle sales and real estate. The process would be used in the same manner with the exception of the product ID information 130 comprising the NAB-IT ID. Along with using SKU, UPC, EAN and GTTN codes, the product ID for the new sectors could be comprised of, but not limited to, VIN, MLS# and inventory numbers.

A decision maker will generally adopt a new way of doing something when the cost-benefit ratio is favorable over alternative methods for completing the equivalent task. Economic efficiency results when maximum benefits are received at minimum cost from resources available. Simultaneous benefits can be realized while reducing cost for both sellers and buyers. In reducing seller cost, the method utilizes the most efficient communication technology available to effectively fill a perceived seller need in a superior manner over time and reducing cost. Targeted seller needs include but are not limited to: (1) reliable information concerning the state of unsatisfied demand for the consumer they target, (2) ability to engage consumer desire at the point of observation, (3) a new sales tool improving access to targeted buyers for responsive stimulation, (4) reliable information for a greater allocative solution, (5) strategic information concerning buyer-segmented product market R&D, (6) improve consumer confidence and loyalty. The competitive market contains the incentive for technological advance. Benefits of new cost-cutting techniques give the innovating firm at least a temporary advantage over its rivals. Lower costs mean economic profits for the pioneering firm. By passing part of this cost reduction to the consumer through lower product price, the firm can increase sales and obtain economic profits at the expense of rival firms. The inexpensive means of acquiring and providing useful information to consumers lowers search costs. The lower product price which the technological advance permits will cause the innovating firm to expand. In reducing buyer cost, the method utilizes the most efficient communication technology available to effectively fill a perceived buyer need in a superior manner over time and reducing cost. Targeted buyer needs include but are not limited to: (1) a new buying approach improving access to promotional seller information concerning a product, (2) ability to monitor exclusive products free from unsolicited seller spam, (3) a new consumer tool reducing time and effort using forward integration of price research to take over routine buyer function, (4) new promotions enabling product consumption, (5) perceive seller interest in consumer well-being. Benefits of the new cost-cutting techniques enhance buyer convenience. Timely information regarding prices assists rational and efficient decisions regarding consumption. Ultimately consumers realize the “income effect”, the impact of a change in price on a consumer's real income and purchasing power.

While certain preferred embodiments of the invention have been described herein, the invention is not to be construed as being so limited, except to the extent that such limitations are found in the claims. One of ordinary skill in the art, in light of the teachings herein, can generate additional embodiments without departing from the spirit of, or exceeding the scope of, the claimed invention. Accordingly it is understood the drawings and the descriptions are proffered by way of example only to facilitate comprehension of the invention and should not be construed to limit the scope thereof.

What is claimed is:

1. An electronically implemented targeted advertising method carried out by a host computer system comprising;
a) receiving, into said host computer system, a plurality of first electronic communications, each of said plurality of first electronic communications containing a return address information, a store ID information and a product ID information;
b) forming, in said host computer system, database records of first electronic communications comprising said return address information for a plurality of the addresses, said store ID information for a plurality of the stores and said product ID information for a plurality of the products;
c) transmitting, from said host computer system, aggregate information to the store ID recorded with the same said product ID information in the database;
d) receiving, into said host computer system, a plurality of second electronic communications, each of said plurality of second electronic communications containing the store ID information, the product ID information and a new promotion information;
e) forming, in said host computer system, database records of second electronic communications comprising said store ID information for the plurality of the stores, said product ID information for the plurality of the products and said new promotion information for a plurality of the promotions;
f) associating, in said host computer system, said database records of first electronic communications and said database records of second electronic communications containing the same said store ID information and said product ID information, and;
g) transmitting, from said host computer system, said new promotion information to said return address information recorded with same said store ID information and said product ID information in the database;
whereby said host computer system targets said advertising as a responsive communication.

2. The method as in claim 1 wherein said return address information received in said first electronic communications comprises login credentials, e-mail identification, cellular number(s), or other identifying means.

3. The method as in claim 2 wherein said product ID information received in said first electronic communications and said second electronic communications comprises a product code.

4. The method as in claim 3 wherein said store ID information received in said first electronic communications comprises location data.

5. The method as in claim 3 further comprising;
a) receiving, into said host computer system, said first electronic communications containing a store ID-site information;
b) forming, in said host computer system, said database records of the first electronic communications comprising said store ID-site information for a plurality of the store sites;
c) applying, in said host computer system, a date queued information to said database records of the first electronic communications;
d) receiving, into said host computer system, said second electronic communications containing the store ID-site information, a price schedule information, a store name information, and a product name information;
e) forming, in said host computer system, said database records of the second electronic communications comprising said store ID-site information for a plurality of the store sites, said price schedule information for a plurality of the price schedules, said store name information for a plurality of the store names, and said product name information for a plurality of the product names;
f) relating, in said host computer system, said date queued information to said price schedule information; the store ID information to said store name information; and the product ID information to said product name information, and;
g) transmitting, from said host computer system, said new promotion information with related: said price schedule information, said store name information, and said product name information to said return address information recorded with same said store ID information and said product ID information in said database.

6. The method as in claim 3 wherein said plurality of first electronic communications are received in MMS protocol, SMS protocol, EMS protocol, or other messaging protocols, and;
wherein said new promotion information is transmitted in the MMS protocol, the SMS protocol, the EMS protocol, or the other messaging protocols to said return address information recorded with same said store ID information and said product ID information in said database.

7. The method as in claim 6 further comprising;
a) receiving, into said host computer system, said first electronic communications containing a store ID-site information;
b) forming, in said host computer system, said database records of the first electronic communications comprising said store ID-site information for a plurality of the store sites;
c) applying, in said host computer system, a date queued information to said database records of the first electronic communications;
d) receiving, into said host computer system, said second electronic communications containing the store ID-site information, a price schedule information, a store name information, and a product name information;
e) forming, in said host computer system, said database records of the second electronic communications comprising said store ID-site information for a plurality of the store sites, said price schedule information for a plurality of the price schedules, said store name information for a plurality of the store names, and said product name information for a plurality of the product names;
f) relating, in said host computer system, said date queued information to said price schedule information; the store ID information to said store name information; and the product ID information to said product name information, and;
g) transmitting, from said host computer system, said new promotion information with related: said price schedule information, said store name information, and said product name information to said return address information recorded with same said store ID information and said product ID information in said database.

8. The method as in claim 6 wherein said store ID information and/or product ID information received in said first electronic communications comprises an image.

9. The method as in claim 3 wherein said product ID information received in said first electronic communications comprises an image.

10. The method as in claim 9 wherein said image contains said store ID information.

11. The method as in claim 9 wherein said store ID information received in said first electronic communications comprises location data.

12. The method as in claim 11 further comprising;
a) receiving, into said host computer system, said first electronic communications containing a store ID-site information;
b) forming, in said host computer system, said database records of the first electronic communications comprising said store ID-site information for a plurality of the store sites;
c) applying, in said host computer system, a date queued information to said database records of the first electronic communications;
d) receiving, into said host computer system, said second electronic communications containing the store ID-site information, a price schedule information, a store name information, and a product name information;
e) forming, in said host computer system, said database records of the second electronic communications comprising said store ID-site information for a plurality of the store sites, said price schedule information for a plurality of the price schedules, said store name information for a plurality of the store names, and said product name information for a plurality of the product names;
f) relating, in said host computer system, said date queued information to said price schedule information; the store ID information to said store name information; and the product ID information to said product name information, and;
g) transmitting, from said host computer system, said new promotion information with related: said price schedule information, said store name information, and said product name information to said return address information recorded with same said store ID information and said product ID information in said database.

13. The method as in claim 11 further comprising;
a) receiving, into said host computer system, a plurality of third electronic communications, said plurality of third electronic communications containing said return address information along with a demographic information;
b) merging, in said host computer system, said plurality of third electronic communications containing said demographic information for a plurality of the demographics into said database records of first electronic communications containing same said return address information;
c) transmitting, from said host computer system, the aggregate information of the merged database records to the store ID recorded with the same product ID in said database.

14. The method as in claim 13 further comprising;
a) receiving, into said host computer system, the plurality of third electronic communications, said plurality of third electronic communications containing said return address information, the store ID information, and the product ID information; along with a resolution information;
b) merging, in said host computer system, said plurality of third electronic communications containing said resolution information for a plurality of the resolutions into said database records of first electronic communications containing same said return address information, the store ID information, and the product ID information.

15. The method as in claim 13 further comprising;
a) receiving, into said host computer system, the plurality of third electronic communications, said plurality of third electronic communications containing said return address information, and the product ID information; along with a perceived value information;
b) merging, in said host computer system, said plurality of third electronic communications containing said perceived value information for a plurality of the perceived values into said database records of first electronic communications containing same said return address information and the product ID information.

16. The method as in claim 15 further comprising;
a) receiving, into said host computer system, the plurality of third electronic communications, said plurality of third electronic communications containing said return address information, the store ID information, and the product ID information; along with a resolution information;
b) merging, in said host computer system, said plurality of third electronic communications containing said resolution information for a plurality of the resolutions into said database records of first electronic communications containing same said return address information, the store ID information, and the product ID information.

17. The method as in claim 3 wherein the product ID information received in said first electronic communications and said second electronic communications comprises said product code selected from the group consisting of SKU, UPC, EAN and GTIN.

18. The method as in claim 3 wherein the product ID information received in said first electronic communications and said second electronic communications comprises said product code selected from the group consisting of VIN, MLS# and inventory numbers.

19. An electronically implemented system for targeted advertising responsive to receiving a request for the advertising comprising;
a) means for receiving a plurality of first electronic communications, each of said plurality of first electronic communications containing a return address information, a store ID information and a product ID information; said receiving means forms a database record for each of said plurality of first electronic communications comprising said return address information for a plurality of the addresses, said store ID information for a plurality of the stores and said product ID information for a plurality of the products;
b) means for transmitting aggregate information from said receiving means to the store ID recorded with the same said product ID in the database records for each of said plurality of first electronic communications;
c) means for receiving a plurality of second electronic communications in said receiving means, each of said plurality of second electronic communications containing the store ID information, the product ID information and a new promotion information; said receiving means forms a database record for each of said plurality of second electronic communications comprising said store ID information for a plurality of the stores, said product ID information for a plurality of the products and said new promotion information for a plurality of the promotions; said receiving means associates the database records of first electronic communications and the database records of second electronic communications containing the same said store ID information and said product ID information, and;
d) means for transmitting said new promotion information from said receiving means to said return address information recorded with the same said store ID information and said product ID information in the database;
whereby said targeted advertising occurs responsive to receiving said request.

20. The communication system as in claim 19 wherein said product ID information comprises a product code selected from the group consisting of SKU, UPC, EAN and GTIN.
